(19) United States
(12) Patent Application Publication
(10) Pub. No.: US 2026/0323201 A1
(43) Pub. Date: Oct. 15, 2026

(54) PASSIVE RADIATOR FOR LIQUID EJECTION

(71) Applicant: Google LLC, Mountain View, CA (US)

(72) Inventors: Timothy Arthur Gladwin, Sunnyvale, CA (US); Jesse Lippert, San Ramon, CA (US)

(21) Appl. No.: 18/869,074

(22) PCT Filed: Dec. 19, 2023
(86) PCT No.: PCT/US2023/084963

§ 371 Date: Nov. 25, 2024

(51) Int. Cl. H04R 1/28; H04R 1/02; H04R 3/00

(52) U.S. Cl. CPC H04R 1/2834; H04R 1/025; H04R 3/007

(57) ABSTRACT

An example device includes an enclosure including a port having an exterior opening and one or more interior openings. The device also includes a speaker positioned, within the enclosure and an electronic device positioned at the one or more interior openings of the port. The device further includes a passive radiator positioned at the one or more interior openings of the port, wherein the passive radiator is operable to be driven by sound emitted by the speaker to vibrate and expel liquid in the port out of the exterior opening of the ort.

### BACKGROUND

A device may include an enclosure that contains various electronic components. Some electronic components, such as speakers and microphones, may require openings in the enclosure to allow sound and/or air to pass through the enclosure.

### SUMMARY

In general, aspects of this disclosure are directed to an enclosure for a device. The enclosure may cover at least a portion of an electronic component of the device that may require an opening in the enclosure, such as a microphone that receives sound or a barometer that receives air from the external environment of the device. As such, the enclosure may include a port that allows air and sound to pass from the external environment into an electronic component that is positioned at an internal opening of the port.

However, liquids may also enter and accumulate inside the port. Such accumulated liquids inside the port may negatively affect the operations of electronic components that are positioned at an interior opening of the port. The accumulated liquids may potentially also physically damage electronic components exposed to the accumulated liquids, such as by causing corrosion, short circuits, or other forms of physical damage to the electronic components.

In accordance with aspects of this disclosure, a device may include a passive radiator positioned at an interior opening of the port that may vibrate to displace accumulated liquids within the port out of an external opening of the port. The passive radiator may be tuned to be driven by sound at a given frequency or within a given frequency range, such that the passive radiator may vibrate in response to sound emitted at the given frequency or within the given frequency range.

A speaker in the device may emit sound at the given frequency or within the given frequency range at which the passive radiator is tuned to be driven, which may cause the passive vibrator to vibrate and displace accumulated liquids within the port out of an external opening of the port. In this way, the techniques of this disclosure may promote efficient expulsion of liquids out of a port of a device, which may increase the performance, reliability, and durability of electronic components that may be affected by the accumulated liquids within the port.

In some aspects, the techniques described herein relate to a device including: an enclosure including a port having an exterior opening and one or more interior openings; a speaker positioned within the enclosure; an electronic device positioned at the one or more interior openings of the port; and a passive radiator positioned at the one or more interior openings of the port, wherein the passive radiator is operable to be driven by sound emitted by the speaker to vibrate and expel liquid in the port out of the exterior opening of the port.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIGS. 1A and 1B are schematic diagrams illustrating a cross-section view of an example device 100, in accordance with one or more aspects of this disclosure.

FIG. 2 is a block diagram illustrating further details of an example device, in accordance with one or more aspects of the present disclosure.

FIG. 3 is a schematic diagram illustrating a cross-section view of an example device, in accordance with one or more aspects of this disclosure.

FIG. 4 is a schematic diagram illustrating a cross-section view of an example device, in accordance with one or more aspects of this disclosure.

FIG. 5 is a schematic diagram illustrating a cross-section view of an example device, in accordance with one or more aspects of this disclosure.

FIG. 6 is a schematic diagram illustrating a cross-section view of an example device, in accordance with one or more aspects of this disclosure.

FIG. 7 is a schematic diagram illustrating a cross-section view of an example device, in accordance with one or more aspects of this disclosure.

### DETAILED DESCRIPTION

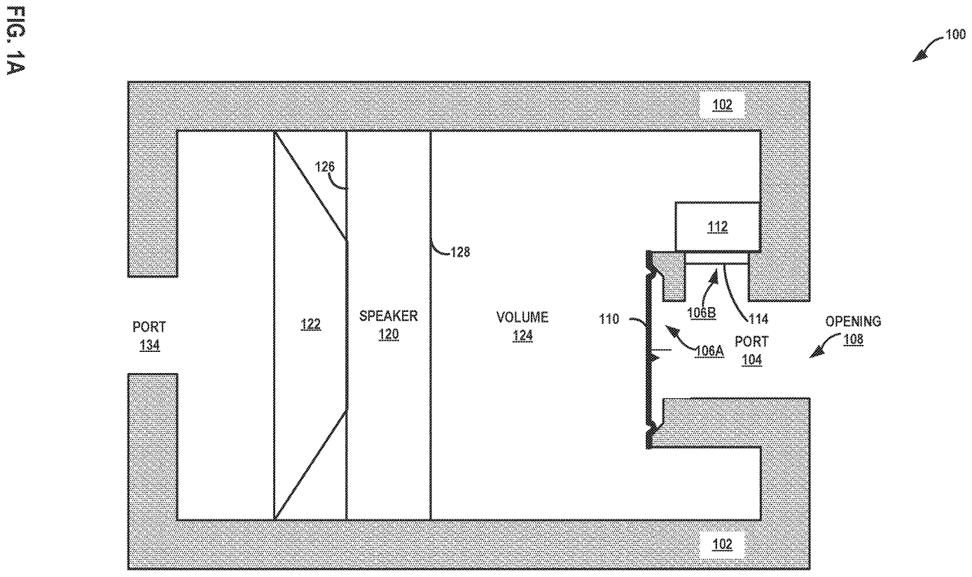

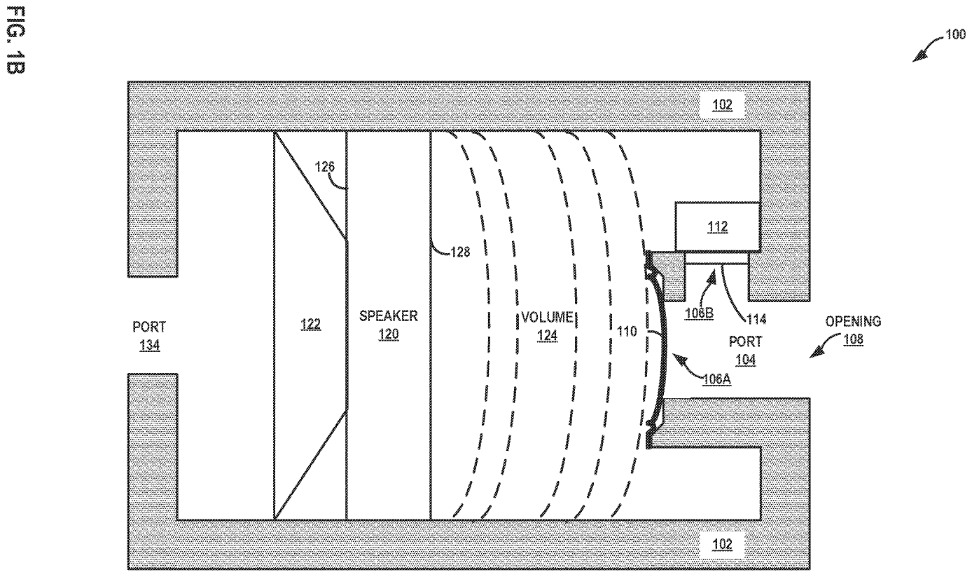

FIGS. 1A and 1B are schematic diagrams illustrating a cross-section view an example device 100, in accordance with one or more aspects of this disclosure. Examples of device 100 include a computing device such as a tablet computer, a laptop computer, a desktop computer, a gaming system, a media player, an e-book reader, a television platform, an automobile navigation system, a wearable computing device (e.g., a computerized watch, computerized eyewear, a computerized glove), or any other type of mobile or non-mobile computing device.

As shown in FIG. 1A, device 100 includes enclosure 102, which may be a physical enclosure, such as an outer case, of device 100, speaker 120, speaker diaphragm 122, and electronic component 112. Enclosure 102 may be made of any suitable material, such as steel, plastic, glass, rubber, or other non-permeable materials, and may be positioned over and may at least partially encloses electronic component 112, speaker 120, and speaker diaphragm 122, to provide a barrier between those components and the environment in which device 100 is positioned.

Speaker 120 may be any suitable audio device, including circuitry, configured to generate and output a sound and/or noise, and speaker diaphragm 122 may vibrate to emit sound produced by speaker 120. To enable sound produced by speaker 120 to pass outside of enclosure 102, enclosure may include port 134 through which sound produced by speaker 120 may pass outside of enclosure 102. Such port 134 may be located on a side of enclosure 102 that faces speaker diaphragm 122.

Speaker 120 may include front side 126 that is coupled to speaker diaphragm 122, such as via voice coils and/or magnets (not shown). Front side 126 of speaker 120 may face port 134. Speaker 120 may also include back side 128 that is on the opposite side of speaker 120 from front side 126. Speaker 120 may be an open-backed speaker, such that back side 128 of speaker 120 may be at least partially open, so that speaker 120 may be able to emit sound out of back side 128 of speaker 120.

Electronic component 112 may be an electronic component such as a microphone, a charging contact, a barometer, acoustic vent, and the like, that requires one or more openings in enclosure 102 to allow sound or air to pass. In the example where electronic component 112 is a microphone, device 100 may also include microphone diaphragm 114.

Enclosure 102 includes port 104 that allows sound and air to pass between electronic component 112 and the external environment of device 100. Port 104 includes exterior opening 108 and one or more interior openings. For example, the one or more openings of port 104 may open into volume 124 within enclosure 102. The one or more openings of port 104 may allow sound and air outside of enclosure 102 to enter port 104 through exterior opening 108 and to reach the one or more interior openings. The one or more openings of port 104 also allow sound and air to enter port 104 from the one or more interior openings and to reach the external environment of device 100 through exterior opening 108.

Electronic component 112 may be positioned at one or more openings of port 104, so that sound and air are able to pass between the external environment of device 100 and electronic component 112 via exterior opening 108 of port 104 and the one or more interior openings of port 104. In the example of FIG. 1A, the one or more interior openings of port 104 includes interior opening 106B, and electronic component 112 may be positioned at interior opening 106B of port 104, so that sound and air are able to pass between the external environment of device 100 and electronic component 112 via exterior opening 108 and interior opening 106B of port 104. Electronic component 112 may be positioned at interior opening 106 by being positioned within device 100 to cover and/or seal interior opening 106B, which may prevent liquid or debris from entering volume 124 via interior opening 106B.

While port 104 may allow air and sound from the external environment of device 100 to enter port 104 via exterior opening 108, liquids such as water may also enter port 104 from the external environment of device 100 via exterior opening 108. For example, device 100 may be exposed to liquids due to rain, liquid spills, being submerged under water, and the like, which may cause such liquids to enter port 104 via exterior opening 108.

While electronic component 112 may be positioned well below the external surface of enclosure 102 to protect electronic component 112 from liquids, liquids may still accumulate in port 104 and may negatively affect the performance of electronic component 112. In the example where electronic component 112 is a microphone, microphone diaphragm 114 may move in reaction to variations in external sound pressure. When liquid is present in port 104, such liquid may affect the sound pressure variations and may also physically obstruct the path of sound waves to electronic component 112 and microphone diaphragm 114, which may degrade the performance of electronic component 112.

In some examples, the interior surfaces of port 104 may be coated with or made of hydrophobic and/or hydrophilic materials. However, such hydrophobic and/or hydrophilic coatings of the interior surfaces of port 104 may not be able to prevent liquids from accumulating in port 104. Furthermore, while speaker 120 may be able to assist in clearing accumulated liquids out of port 104 via movements of the speaker diaphragm, placing speaker 120 at one or more interior openings of port 104 may cause unwanted interactions with electronic component 112, such as by causing feedback and/or echo in examples where electronic component 112 is a microphone.

In accordance with aspects of this disclosure, device 100 may include passive radiator 110 positioned at one or more interior openings of port 104. Passive radiator 110 may be operable to be driven by sound emitted by speaker 120 at a certain frequency to vibrate, and the movement of passive radiator 110's vibrations may displace and expel liquids within port 104 out of port 104 via exterior opening 108 of port 104. Using passive radiator 110 to displace and expel accumulated liquids out of port 104 may promote efficient expulsion of liquids out of 104 without causing unwanted interactions with electronic component 112 and may increase the performance, reliability, and durability of electronic component 112 that may be affected by the accumulated liquids within port 104.

In the example of FIG. 1A, the one or more interior openings of port 104 may include interior opening 106B at which electronic component 112 is positioned at interior opening 106A, and passive radiator 110 may be positioned at interior opening 106A. While FIG. 1A illustrates port 104 having interior opening 106A at which passive radiator 110 is positioned at interior opening 106B at which passive radiator 110 is positioned, port 104 may, in some examples, have fewer or more openings. For example, port 104 may have exterior opening 108 and a single interior opening at which both electronic component 112 and passive radiator 110 are positioned.

Interior openings 106A and 106B of port 104 may be positioned in any suitable arrangement. In the example of FIG. 1A, interior opening 106B of port 104 may be positioned such that port 104 forms a non-straight conduit between exterior opening 108 of port 104 and interior opening 106B of port 104, such as an L-shaped conduit, which may help to protect electrical component 112 from liquids in port 104, while interior opening 106A of port 104 may be positioned such that port 104 forms a straight conduit between exterior opening 108 of port 104 and interior opening 106A of port 104.

Passive radiator 110 may be positioned at interior opening 106A of port 104 to cover and/or seal interior opening 106A of port 104. Passive radiator 110 may be positioned between exterior opening 108 of port 104 and volume 124 within enclosure 102, and passive radiator 110 may, by covering and/or sealing interior opening of port 104, prevent liquid or debris from entering volume 124 via interior opening 106A.

Passive radiator 110 may be a diaphragm made of a stiff and relatively heavy material attached to a suspension system and may be tuned to vibrate sympathetically with air movements in volume 124 caused by speaker 120. For example, when the active driver(s) of speaker 120 moves, such movement creates pressure changes within volume 124, which causes passive radiator 110 to vibrate.

Passive radiator 110 is positioned in device 100 opposite back side 128 of speaker 120 and is separated by volume 124 from back side 128 of speaker 120. Speaker 120 may include front side 126 and back side 128. Front side 126 of speaker 120 may be the side of speaker 120 that is coupled to speaker diaphragm 122 and that faces port 134, and back side 128 of speaker 120 may be on the opposing side of speaker 120 from front side 126 of speaker 120. Unlike a speaker diaphragm, such as speaker diaphragm 122, passive radiator 110 is not coupled to speaker 120 and is not coupled to a voice coil and/or a magnet of speaker 120. Furthermore, unlike speaker diaphragm 122 that is coupled to a front side 126 of speaker 120, passive radiator 110 is positioned to face back side 128 of speaker 120. For example, one side of the surface of passive radiator 110 may face towards back side 128 of speaker 120, such as by being positioned parallel to back side 128 of speaker 120.

Passive radiator 110 that is used to expel liquids out of port 104, as described in this disclosure, may not provide audible support for speaker 120. That is, passive radiator 110 may not operate to increase the overall volume or bass response of speaker 120.

Passive radiator 110 may be tuned to resonate at a specific frequency or a specific frequency range. That is, passive radiator 110 (e.g., the diaphragm of passive radiator 110) may be tuned to vibrate when speaker 120 emits sound at a frequency or within a frequency range at which passive radiator 110 is tuned to resonate. When speaker 120 emits sound that is not at the frequency and/or is not within the frequency range at which passive radiator 110 is tuned to resonate, the sound emitted by speaker 120 may not cause passive radiator 110 to vibrate or otherwise move. Throughout this disclosure, passive radiator 110 that is tuned to resonate at a specific frequency or a specific frequency range may be referred to as operating at the specific frequency or the specific frequency range, or as being tuned to be driven at the specific frequency or the specific frequency range.

Passive radiator 110 may be tuned to be driven at a sound frequency that is lower than typically used by speaker 120 to boost bass frequencies, and may be tuned to minimize the effect of the sound frequency on electronic component 112. In the example where electronic component 112 is a barometer, passive radiator 110 may be tuned to be driven at a sound frequency that minimizes barometer error rates. In the example where electronic component 112 is a microphone, passive radiator 110 may be tuned to be driven at a sound frequency that is below a passband of the microphone, such as a sound frequency that is less than or equal to 100 Hertz. That is, passive radiator 110 may be tuned to operate at a frequency that is below device 100's desired frequency range for a microphone, such that the sound frequency may be subaudible to the microphone, and which may minimize any possible feedback or echo that may be picked up by the microphone.

In some examples, passive radiator 110 may be tuned to be driven at a sound frequency that is below 100 Hertz or at a sound frequency that is between 10 Hertz and 100 Hertz. In some examples, passive radiator 110 may be tuned to be driven at a sound frequency that is at the bottom of a telephony range, which may be a sound frequency that is at or below 200 Hertz, such as a sound frequency between 100 Hertz and 100 Hertz.

As shown in FIG. 1B, when speaker 120 plays sound at the sound frequency at which passive radiator 110 operates, the sound waves may travel from back side 128 of speaker 120 through volume 124 to passive radiator 110. The acoustic backweight of the sound waves may cause passive radiator 110 to vibrate and to push passive radiator 110 outwards away from volume 124 and towards port 104. By pushing passive radiator 110 outwards, the sound waves cause passive radiator 110 to push liquids that have accumulated in port 104 out of port 104 via exterior opening 108. When speaker 120 stops playing the sound, passive radiator 110 may contract inwards towards volume 124, and port 104 may draw in air from the exterior of device 100 via exterior opening 108. Speaker 120 may play sound that causes passive radiator 110 to push outwards and then contract inwards multiple times a second, such as ten to one hundred times a second, in order to clear port 104 of accumulated liquids.

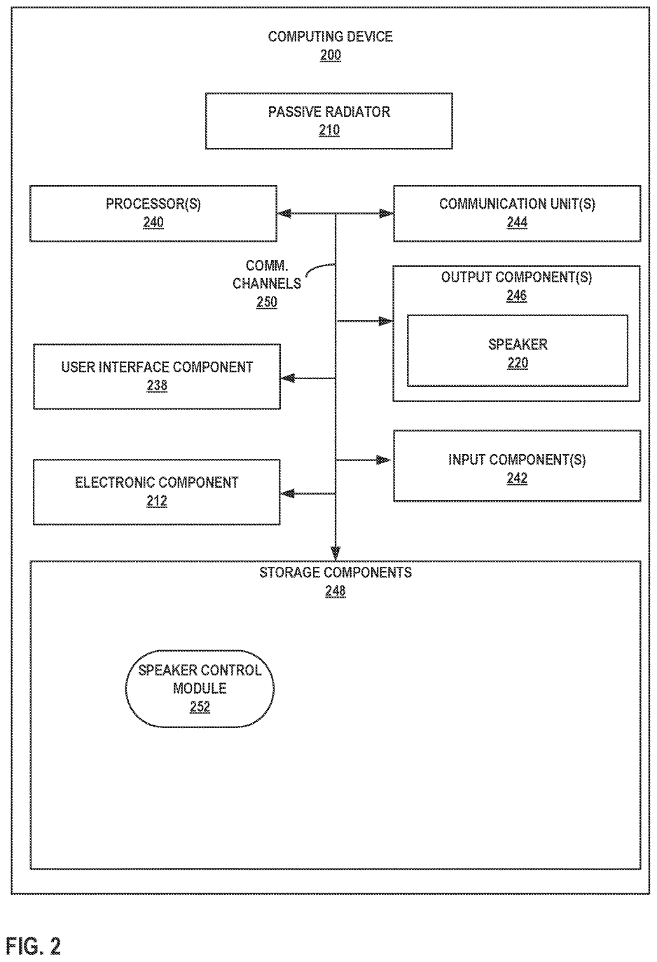

FIG. 2 is a block diagram illustrating further details of an example device 200, in accordance with one or more aspects of the present disclosure. Device 200 of FIG. 2 is described below as an example of device 100 as illustrated in FIGS. 1A and 1B.

Device 200 of FIG. 2 may be an example of a mobile phone, a tablet computer, a laptop computer, a desktop computer, a wearable device, a home automation device or system, a gaming system, a media player, an e-book reader, a mobile television platform, an automobile navigation or infotainment system, or any other type of mobile, non-mobile, wearable, and non-wearable computing device. FIG. 2 illustrates only one particular example of device 200, and many other examples of device 200 may be used in other instances and may include a subset of the components included in example device 200 or may include additional components not shown in FIG. 2.

As shown in the example of FIG. 2, device 200 includes passive radiator 210, electronic component 212, user interface component (UIC) 238, one or more processors 240, one or more input components 242, one or more communication units 244, one or more output components 246, and one or more storage components 248. One or more output components 246 include speaker 220, which is an example of speaker 120 of FIGS. 1A and 1B. Storage components 248 of device 200 also include speaker control module 252. Passive radiator 210 is an example of passive radiator 110 of FIGS. 1A and 1B, and electronic component 212 is an example of electronic component 112 of FIGS. 1A and 1B.

Communication channels 250 may interconnect each of components 212, 238, 240, 244, 246, 242, and 248 for inter-component communications (physically, communicatively, and/or operatively). In some examples, communication channels 250 may include a system bus, a network connection, an inter-process communication data structure, or any other method for communicating data.

Passive radiator 210 may be tuned to resonate at a specific frequency or a specific frequency range. That is, passive radiator 210 (e.g., the diaphragm of passive radiator 210) may be tuned to vibrate when a speaker (e.g., speaker 220) emits sound at a frequency or within a frequency range at which passive radiator 210 is tuned to resonate. When the speaker emits sound that is not at the frequency and/or is not within the frequency range at which passive radiator 210 is tuned to resonate, the sound emitted by the speaker may not cause passive radiator 110 to vibrate or otherwise move. Passive radiator 210 may be positioned at an interior opening of a port to expel liquids accumulated within the port out of the port.

Electronic component 212 may be a microphone, a charging contact, a barometer, or another suitable electronic component that requires one or more openings in the enclosure of device 200 to allow sound or air to pass. In the example where electronic component 212 is a microphone, device 200 may also include a microphone diaphragm operably coupled to electronic component 212.

One or more input components 242 of device 200 may receive input. Examples of input are tactile, audio, and video input. One or more input components 242 of device 200, in one example, includes a presence-sensitive display, touch-sensitive screen, mouse, keyboard, voice responsive system, video camera, microphone or any other type of device for detecting input from a human or machine. In some examples, one or more input components 242 may include electronic component 212.

One or more output components 246 of device 200 may generate output. Examples of output are tactile, audio, and video output. One or more output components 246 of device 200, in one example, includes a presence-sensitive display, sound card, video graphics adapter card, speaker, liquid crystal display (LCD), organic light-emitting diode (OLED) display, a light field display, haptic motors, linear actuating devices, or any other type of device for generating output to a human or machine. One or more output components 246 may include speaker 220, which may be any suitable audio device, including circuitry, configured to generate and output a sound and/or noise.

One or more communication units 244 of device 200 may communicate with external devices via one or more wired and/or wireless networks by transmitting and/or receiving network signals on the one or more networks. Examples of one or more communication units 244 include a network interface card (e.g., an Ethernet card), an optical transceiver, a radio frequency transceiver, a GPS receiver, or any other type of device that can send and/or receive information. Other examples of one or more communication units 244 may include short wave radios, cellular data radios, wireless network radios, as well as universal serial bus (USB) controllers.

UIC 238 of device 200 may be hardware that functions as an input and/or output device for device 200. For example, UIC 238 may include a display component, which may be a screen at which information is displayed by UIC 238 and a presence-sensitive input component that may detect an object at and/or near the display component.

One or more processors 240 may implement functionality and/or execute instructions within device 200. For example, one or more processors 240 on device 200 may receive and execute instructions stored by storage components 248 that execute the functionality of speaker control module 252. The instructions executed by one or more processors 240 may cause device 200 to store information within storage components 248 during program execution. Examples of one or more processors 240 include application processors, display controllers, sensor hubs, and any other hardware configured to function as a processing unit. One or more processors 240 may execute instructions of speaker control module 252 to perform actions or functions. That is, speaker control module 252 may be operable by one or more processors 240 to perform various actions or functions of device 200.

One or more storage components 248 within device 200 may store information for processing during operation of device 200. That is, device 200 may store data accessed by speaker control module 252 during execution at device 200. In some examples, storage component 248 is a temporary memory, meaning that a primary purpose of storage component 248 is not long-term storage. Storage components 248 on device 200 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 may be configured to store larger amounts of information than volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with communication module 244.

One or more processors 240 are configured to execute speaker control module 252 to drive speaker 220 to generate and output sound. Speaker control module 252 may send one or more signals to speaker 220 to cause speaker 220 to generate and output sound at a frequency or within a frequency range at which passive radiator 210 is tuned to resonate to thereby cause passive radiator 210 to vibrate. For example, speaker control module 252 may cause speaker 220 to generate and output multiple times a second, such as ten to one hundred times a second, sound at a frequency or within a frequency range at which passive radiator 210 is tuned to resonate. In some examples, speaker control module 252 may cause speaker 220 to generate and output sound at a frequency or within a frequency range at which passive radiator 210 is tuned to resonate in response to UIC 238 receiving user input selecting a liquid ejection functionality.

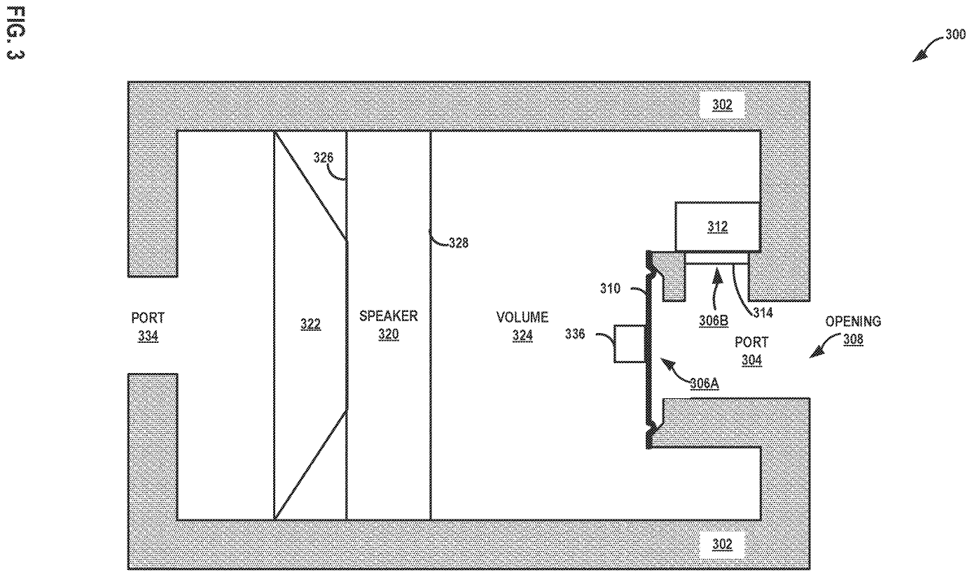

FIG. 3 is a schematic diagram illustrating a cross-section view of an example device 300, in accordance with one or more aspects of this disclosure. Device 300 is an example of device 100 of FIGS. 1A and 1B.

As shown in FIG. 3, device 300 includes enclosure 302, which is an example of enclosure 102 of FIGS. 1A and 1B, speaker 320, which is an example of speaker 120 of FIGS. 1A and 1B, speaker diaphragm 322, which is an example of speaker diaphragm 122 of FIGS. 1A and 1B, electronic component 312, which is an example of electronic component 112 of FIGS. 1A and 1B, and passive radiator 310, which is an example of passive radiator 110 of FIGS. 1A and 1B. In the example where electronic component 312 is a microphone, device 300 may also include microphone diaphragm 314, which is an example of microphone diaphragm 114 of FIGS. 1A and 1B.

Enclosure 302 may include port 334, which is an example of port 134 of FIGS. 1A and 1B, that allows sound produced by speaker 320 to pass outside of enclosure 302. Enclosure 302 may also include port 304, which is an example of port 104 of FIGS. 1A and 1B, that allows sound and air to pass between electronic component 312 and the external environment of device 300. Port 304 includes exterior opening 308, which is an example of exterior opening 108 of port 104 of FIGS. 1A and 1B, interior opening 306A, which is an example of interior opening 106A of port 104 of FIGS. 1A and 1B, and interior opening 306B, which is an example of interior opening 106B of port 104 of FIGS. 1A and 1B. Exterior opening 308, interior opening 306A, and interior opening 306B allow sound and air outside of enclosure 302 to enter port 304 through exterior opening 308 and to reach interior opening 306A and interior opening 306B, and that allows sound and air to enter port 304 through interior opening 306A and/or interior opening 306B and to reach the external environment of device 300 through exterior opening 308.

Electronic component 312 may be positioned at interior opening 306B of port 304, so that sound and air are able to pass between the external environment of device 100 and electronic component 312 via exterior opening 308 and interior opening 306B of port 304. Electronic component 312 may be positioned at interior opening 306B to cover and/or seal interior opening 306B, which may prevent liquid or debris from entering volume 324 via interior opening 306B.

Passive radiator 310 may be positioned at interior opening 306A of port 304 and may cover and/or seal interior opening 306A of port 304. Passive radiator 310 may be positioned between exterior opening 308 of port 304 and volume 324 within enclosure 302, and passive radiator 310 may, by covering and/or sealing interior opening 306A of port 304, prevent liquid or debris from entering volume 324 via interior opening 306A.

Passive radiator 310 is positioned in device 300 opposite back side 328 of speaker 320 and is separated by volume 324 from back side 328 of speaker 320. Speaker 320 may include front side 326 and back side 328. Front side 326 of speaker 320 may be the side of speaker 320 that is coupled to speaker diaphragm 322 and that faces port 334, and back side 328 of speaker 320 may be on the opposing side of speaker 320 from front side 326 of speaker 320.

Passive radiator 310 may be tuned to resonate at a specific frequency or a specific frequency range, and may therefore vibrate when speaker 320 emits sound at a frequency or within a frequency range to which passive radiator 310 is tuned. Thus, when speaker 320 plays sound at the sound frequency at which passive radiator 310 operates, the sound waves may push passive radiator 310 outwards towards port 304 to push liquids that have accumulated in port 304 out of port 304 via exterior opening 308. When speaker 320 stops playing the sound, passive radiator 310 may contract inwards towards volume 324, and port 304 may draw in air from the exterior of device 300 via exterior opening 308.

In the example of FIG. 3, device 300 includes barometric vent 336 coupled to the membrane of passive radiator 310. Barometric vent 336 is operable to equalize long term variations in the internal pressure within volume 324 to the ambient barometric pressure in the external environment of device 300.

Because passive radiator 310 and electronic component 312 may seal openings 306A and 306B from volume 324 and because speaker 320 may seal port 334 from volume 324, volume 324 may include barometric vent 336 that may open and close as needed in order to equalize long term variations in the internal pressure within volume 324 to the ambient barometric pressure in the external environment of device 300. Positioning barometric vent 336 on the membrane of passive radiator 310 may also facilitate ejecting liquids from barometric vent 336.

Barometric vent 336 may have a time constant that corresponds to the responsiveness of barometric vent 336 to changes in the pressure. For example, the time constant may be the time it takes for barometric vent 336 to respond to a specified amount of change in pressure. The time constant of barometric vent 336 may be well below the operating range of speaker 320 and electronic component 312. For example, the time constant tv of barometric vent 336 may have a range of 0.1 second<tv<100 seconds. Passive radiator 310 may provide pressure relief for faster transient changes in pressure, such as in the range of 0.01 s to 0.05 seconds, which may allow for barometric vent 336 to have a slower response time or better water resistance.

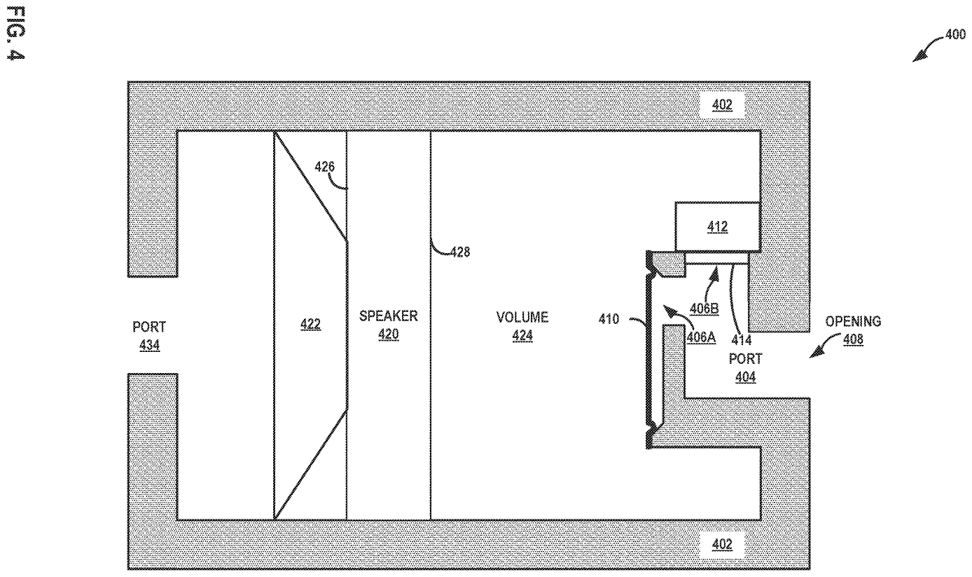

FIG. 4 is a schematic diagram illustrating a cross-section view of an example device 400, in accordance with one or more aspects of this disclosure. Device 400 is an example of device 100 of FIGS. 1A and 1B.

As shown in FIG. 4, device 400 includes enclosure 402, which is an example of enclosure 102 of FIGS. 1A and 1B, speaker 420, which is an example of speaker 120 of FIGS. 1A and 1B, speaker diaphragm 422, which is an example of speaker diaphragm 122 of FIGS. 1A and 1B, electronic component 112, which is an example of electronic component 112 of FIGS. 1A and 1B, and passive radiator 410, which is an example of passive radiator 110 of FIGS. 1A and 1B. In the example where electronic component 412 is a microphone, device 400 may also include microphone diaphragm 414, which is an example of microphone diaphragm 114 of FIGS. 1A and 1B.

Enclosure 402 may include port 434, which is an example of port 134 of FIGS. 1A and 1B, that allows sound produced by speaker 420 to pass outside of enclosure 402. Enclosure 402 may also include port 404, which is an example of port 104 of FIGS. 1A and 1B, that allows sound and air to pass between electronic component 412 and the external environment of device 400. Port 404 includes exterior opening 408, which is an example of exterior opening 108 of port 104 of FIGS. 1A and 1B, interior opening 406A, which is an example of interior opening 106A of port 104 of FIGS. 1A and 1B, and interior opening 406B, which is an example of interior opening 106B of port 104 of FIGS. 1A and 1B. Exterior opening 408, interior opening 406A, and interior opening 406B allow sound and air outside of enclosure 402 to enter port 404 through exterior opening 408 and to reach interior opening 406A and interior opening 406B, and that allows sound and air to enter port 404 through interior opening 406A and/or interior opening 406B and to reach the external environment of device 400 through exterior opening 408.

Electronic component 412 may be positioned at interior opening 406B of port 404, so that sound and air are able to pass between the external environment of device 100 and electronic component 412 via exterior opening 408 and interior opening 406B of port 404. Electronic component 412 may be positioned at interior opening 406B to cover and/or seal interior opening 406B, which may prevent liquid or debris from entering volume 424 via interior opening 406B.

Passive radiator 410 may be positioned at interior opening 406A of port 404 and may cover and/or seal interior opening 406A of port 404. Passive radiator 410 may be positioned between exterior opening 408 of port 404 and volume 424 within enclosure 402, and passive radiator 410 may, by covering and/or sealing interior opening 406A of port 404, prevent liquid or debris from entering volume 424 via interior opening 406A.

Passive radiator 410 is positioned in device 400 opposite back side 428 of speaker 420 and is separated by volume 424 from back side 428 of speaker 420. Speaker 420 may include front side 426 and back side 428. Front side 426 of speaker 420 may be the side of speaker 420 that is coupled to speaker diaphragm 422 and that faces port 434, and back side 428 of speaker 420 may be on the opposing side of speaker 420 from front side 426 of speaker 420.

Passive radiator 410 may be tuned to resonate at a specific frequency or a specific frequency range, and may therefore vibrate when speaker 420 emits sound at a frequency or within a frequency range to which passive radiator 410 is tuned. Thus, when speaker 420 plays sound at the sound frequency at which passive radiator 410 operates, the sound waves may push passive radiator 410 outwards towards port 404 to push liquids that have accumulated in port 404 out of port 404 via exterior opening 408. When speaker 420 stops playing the sound, passive radiator 410 may contract inwards towards volume 424. and port 404 may draw in air from the exterior of device 400 via exterior opening 408.

Enclosure 402 may form port 404 in any suitable shape to improve the ejection of liquids out of port 404 and/or to counteract parasitic speaker-microphone resonant coupling. That is, port 404 may be designed to decrease the possibility of speaker 420's output at certain frequencies causing electronic component 412 to resonate and to more effectively pick up sound, which may cause feedback loops and sound distortion.

In the example of FIG. 4, interior opening 406A of port 404 is positioned so that port 404 forms a non-straight conduit between exterior opening 408 of port 404 and interior opening 406A of port 404. Instead, interior opening 406A may be offset so that interior opening 406A is relatively close to interior opening 406B.

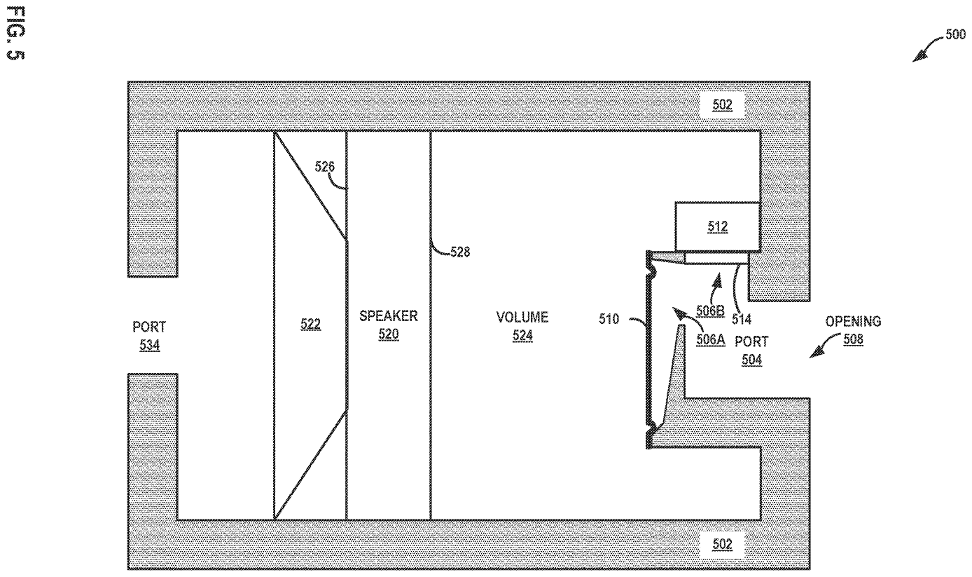

FIG. 5 is a schematic diagram illustrating a cross-section view of an example device 500, in accordance with one or more aspects of this disclosure. Device 500 is an example of device 100 of FIGS. 1A and 1B.

As shown in FIG. 5, device 500 includes enclosure 502, which is an example of enclosure 102 of FIGS. 1A and 1B, speaker 520, which is an example of speaker 120 of FIGS. 1A and 1B, speaker diaphragm 522, which is an example of speaker diaphragm 122 of FIGS. 1A and 1B, electronic component 512, which is an example of electronic component 112 of FIGS. 1A and 1B, and passive radiator 510, which is an example of passive radiator 110 of FIGS. 1A and 1B. In the example where electronic component 512 is a microphone, device 500 may also include microphone diaphragm 514, which is an example of microphone diaphragm 114 of FIGS. 1A and 1B.

Enclosure 502 may include port 534, which is an example of port 134 of FIGS. 1A and 1B, that allows sound produced by speaker 520 to pass outside of enclosure 502. Enclosure 502 may also include port 504, which is an example of port 104 of FIGS. 1A and 1B, that allows sound and air to pass between electronic component 512 and the external environment of device 500. Port 504 includes exterior opening 508, which is an example of exterior opening 108 of port 104 of FIGS. 1A and 1B, interior opening 506A, which is an example of interior opening 106A of port 104 of FIGS. 1A and 1B, and interior opening 506B, which is an example of interior opening 106B of port 104 of FIGS. 1A and 1B. Exterior opening 508, interior opening 506A, and interior opening 506B allow sound and air outside of enclosure 502 to enter port 504 through exterior opening 508 and to reach interior opening 506A and interior opening 506B, and that allows sound and air to enter port 504 through interior opening 506A and/or interior opening 506B and to reach the external environment of device 500 through exterior opening 508.

Electronic component 512 may be positioned at interior opening 506B of port 504, so that sound and air are able to pass between the external environment of device 100 and electronic component 512 via exterior opening 508 and interior opening 506B of port 504. Electronic component 512 may be positioned at interior opening 506B to cover and/or seal interior opening 506B, which may prevent liquid or debris from entering volume 524 via interior opening 506B.

Passive radiator 510 may be positioned at interior opening 506A of port 504 and may cover and/or seal interior opening 506A of port 504. Passive radiator 510 may be positioned between exterior opening 508 of port 504 and volume 524 within enclosure 502, and passive radiator 510 may, by covering and/or sealing interior opening 506A of port 504, prevent liquid or debris from entering volume 524 via interior opening 506A.

Passive radiator 510 is positioned in device 500 opposite back side 528 of speaker 520 and is separated by volume 524 from back side 528 of speaker 520. Speaker 520 may include front side 526 and back side 528. Front side 526 of speaker 520 may be the side of speaker 520 that is coupled to speaker diaphragm 522 and that faces port 534, and back side 528 of speaker 520 may be on the opposing side of speaker 520 from front side 526 of speaker 520.

Passive radiator 510 may be tuned to resonate at a specific frequency or a specific frequency range, and may therefore vibrate when speaker 520 emits sound at a frequency or within a frequency range to which passive radiator 510 is tuned. Thus, when speaker 520 plays sound at the sound frequency at which passive radiator 510 operates, the sound waves may push passive radiator 510 outwards towards port 504 to push liquids that have accumulated in port 504 out of port 504 via exterior opening 508. When speaker 520 stops playing the sound, passive radiator 510 may contract inwards towards volume 524, and port 504 may draw in air from the exterior of device 500 via exterior opening 508.

In the example of FIG. 5, interior opening 506A of port 504 is positioned to so that port 504 forms a non-straight conduit between exterior opening 508 of port 504 and interior opening 506A of port 504. Instead, interior opening 506A may be offset so that interior opening 506A is very close to interior opening 506B. For example, interior opening 506A may adjoin interior opening 506B. Such positioning of interior opening 506A to be very close to interior opening 506B and/or to adjoin interior opening 506B may improve passive radiator 500's performance in ejecting liquids out of port 504.

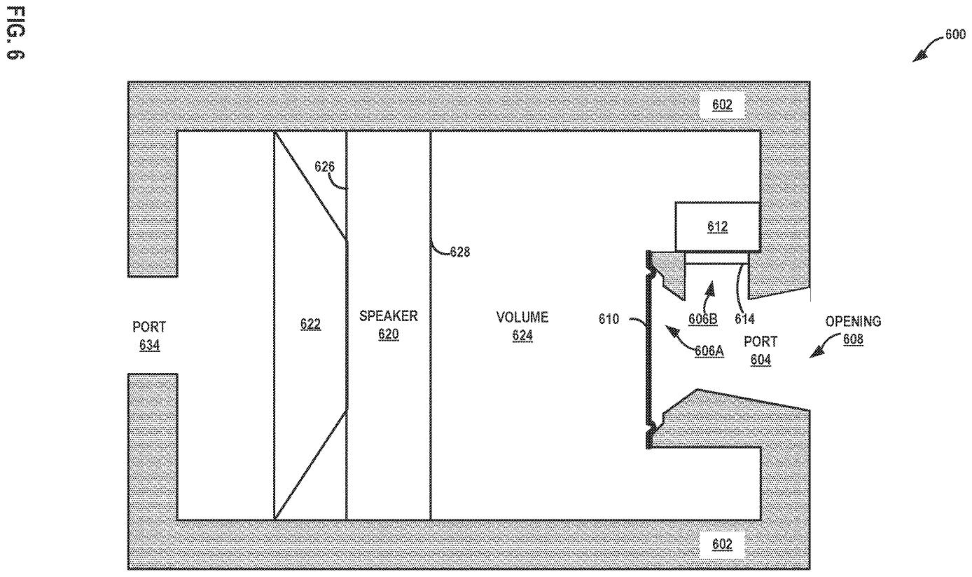

FIG. 6 is a schematic diagram illustrating a cross-section view of an example device 600, in accordance with one or more aspects of this disclosure. Device 600 is an example of device 100 of FIGS. 1A and 1B.

As shown in FIG. 6, device 600 includes enclosure 602, which is an example of enclosure 102 of FIGS. 1A and 1B, speaker 620, which is an example of speaker 120 of FIGS. 1A and 1B, speaker diaphragm 622, which is an example of speaker diaphragm 122 of FIGS. 1A and 1B, electronic component 612, which is an example of electronic component 112 of FIGS. 1A and 1B, and passive radiator 610, which is an example of passive radiator 110 of FIGS. 1A and 1B. In the example where electronic component 612 is a microphone, device 600 may also include microphone diaphragm 614, which is an example of microphone diaphragm 114 of FIGS. 1A and 1B.

Enclosure 602 may include port 634, which is an example of port 134 of FIGS. 1A and 1B, that allows sound produced by speaker 620 to pass outside of enclosure 602. Enclosure 602 may also include port 604, which is an example of port 104 of FIGS. 1A and 1B, that allows sound and air to pass between electronic component 612 and the external environment of device 600. Port 604 includes exterior opening 608, which is an example of exterior opening 108 of port 104 of FIGS. 1A and 1B, interior opening 606A, which is an example of interior opening 106A of port 104 of FIGS. 1A and 1B, and interior opening 606B, which is an example of interior opening 106B of port 104 of FIGS. 1A and 1B. Exterior opening 608, interior opening 606A, and interior opening 606B allow sound and air outside of enclosure 602 to enter port 604 through exterior opening 608 and to reach interior opening 606A and interior opening 606B, and that allows sound and air to enter port 604 through interior opening 606A and/or interior opening 606B and to reach the external environment of device 600 through exterior opening 608.

Electronic component 612 may be positioned at interior opening 606B of port 604, so that sound and air are able to pass between the external environment of device 100 and electronic component 612 via exterior opening 608 and interior opening 606B of port 604. Electronic component 612 may be positioned at interior opening 606B to cover and/or seal interior opening 606B, which may prevent liquid or debris from entering volume 624 via interior opening 606B.

Passive radiator 610 may be positioned at interior opening 606A of port 604 and may cover and/or seal interior opening 606A of port 604. Passive radiator 610 may be positioned between exterior opening 608 of port 604 and volume 624 within enclosure 602, and passive radiator 610 may, by covering and/or sealing interior opening 606A of port 604, prevent liquid or debris from entering volume 624 via interior opening 606A.

Passive radiator 610 is positioned in device 600 opposite back side 628 of speaker 620 and is separated by volume 624 from back side 628 of speaker 620. Speaker 620 may include front side 626 and back side 628. Front side 626 of speaker 620 may be the side of speaker 620 that is coupled to speaker diaphragm 622 and that faces port 634, and back side 628 of speaker 620 may be on the opposing side of speaker 620 from front side 626 of speaker 620.

Passive radiator 610 may be tuned to resonate at a specific frequency or a specific frequency range, and may therefore vibrate when speaker 620 emits sound at a frequency or within a frequency range to which passive radiator 610 is tuned. Thus, when speaker 620 plays sound at the sound frequency at which passive radiator 610 operates, the sound waves may push passive radiator 610 outwards towards port 604 to push liquids that have accumulated in port 604 out of port 604 via exterior opening 608. When speaker 620 stops playing the sound, passive radiator 610 may contract inwards towards volume 624, and port 604 may draw in air from the exterior of device 600 via exterior opening 608.

In the example of FIG. 6, port 604 may form a Venturi tube between interior opening 606A and exterior opening 608 to aid ejection of liquids out of exterior opening 608 of port 604. By forming a Venturi tube, port 604 may create a pressure differential between the portion of port 604 near interior opening 606A and the portion of port 604 near exterior opening 608. The pressure differential may increase the speed at which liquids flow out of exterior opening 608 of port 604, which may enable the vibrations of passive radiator 610 to more effectively eject liquids out of port 604 via exterior opening 608.

Port 604 may form a Venturi tube having an entry cone that meets an exit cone. Interior opening 606A of port 604 may be an opening of an entry cone of the Venturi tube, and exterior opening 608 of port 604 may be an opening of an exit cone of the Venturi tube. The entry cone and the exit cone may meet within port 604. The entry cone may expand from where the entry cone and the exit cone meet towards interior opening 606A at a specific entry angle. Similarly, the exit cone may expand from where the entry cone and the exit cone meet towards exterior opening 608 at a specific exit angle. The entry angle of the entry cone may be approximately 30 degrees, and the exit angle of the exit cone may be approximately 5 degrees.

The cross-sectional area of interior opening 606A of port 604 may therefore be larger than the cross-sectional area of exterior opening 608 of port 604. Further, the cross-sectional arca of port 604 where the entry cone of the Venturi tube meets the exit cone of the Venturi tube may be smaller than either of the cross-sectional area of interior opening 606A and the cross-sectional area of exterior opening 608.

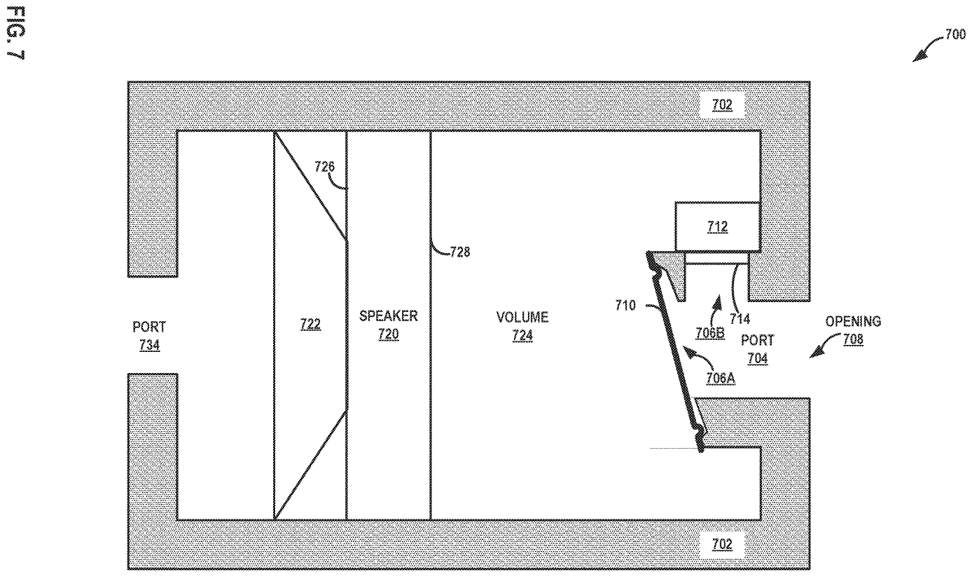

FIG. 7 is a schematic diagram illustrating a cross-section view of an example device 700, in accordance with one or more aspects of this disclosure. Device 700 is an example of device 100 of FIGS. 1A and 1B.

As shown in FIG. 7, device 700 includes enclosure 702, which is an example of enclosure 102 of FIGS. 1A and 1B, speaker 720, which is an example of speaker 120 of FIGS. 1A and 1B, speaker diaphragm 722, which is an example of speaker diaphragm 122 of FIGS. 1A and 1B, electronic component 712, which is an example of electronic component 112 of FIGS. 1A and 1B, and passive radiator 710, which is an example of passive radiator 110 of FIGS. 1A and 1B. In the example where electronic component 712 is a microphone, device 700 may also include microphone diaphragm 714, which is an example of microphone diaphragm 114 of FIGS. 1A and 1B.

Enclosure 702 may include port 734, which is an example of port 134 of FIGS, 1A and 1B, that allows sound produced by speaker 720 to pass outside of enclosure 702. Enclosure 702 may also include port 704, which is an example of port 104 of FIGS. 1A and 1B, that allows sound and air to pass between electronic component 712 and the external environment of device 700. Port 704 includes exterior opening 708, which is an example of exterior opening 108 of port 104 of FIGS. 1A and 1B, interior opening 706A, which is an example of interior opening 106A of port 104 of FIGS. 1A and 1B, and interior opening 706B, which is an example of interior opening 106B of port 104 of FIGS. 1A and 1B. Exterior opening 708, interior opening 706A, and interior opening 706B allow sound and air outside of enclosure 702 to enter port 704 through exterior opening 708 and to reach interior opening 706A and interior opening 706B, and that allows sound and air to enter port 704 through interior opening 706A and/or interior opening 706B and to reach the external environment of device 700 through exterior opening 708.

Electronic component 712 may be positioned at interior opening 706B of port 704, so that sound and air are able to pass between the external environment of device 100 and electronic component 712 via exterior opening 708 and interior opening 706B of port 704. Electronic component 712 may be positioned at interior opening 706B to cover and/or seal interior opening 706B, which may prevent liquid or debris from entering volume 724 via interior opening 706B.

Passive radiator 710 may be positioned at interior opening 706A of port 704 and may cover and/or seal interior opening 706A of port 704. Passive radiator 710 may be positioned between exterior opening 708 of port 704 and volume 724 within enclosure 702, and passive radiator 710 may, by covering and/or sealing interior opening 706A of port 404, prevent liquid or debris from entering volume 724 via interior opening 706A.

Passive radiator 710 is positioned in device 700 opposite back side 728 of speaker 720 and is separated by volume 724 from back side 728 of speaker 720. Speaker 720 may include front side 726 and back side 728. Front side 726 of speaker 720 may be the side of speaker 720 that is coupled to speaker diaphragm 722 and that faces port 734, and back side 728 of speaker 720 may be on the opposing side of speaker 720 from front side 726 of speaker 720.

Passive radiator 710 may be tuned to resonate at a specific frequency or a specific frequency range, and may therefore vibrate when speaker 720 emits sound at a frequency or within a frequency range to which passive radiator 710 is tuned. Thus, when speaker 720 plays sound at the sound frequency at which passive radiator 710 operates, the sound waves may push passive radiator 710 outwards towards port 704 to push liquids that have accumulated in port 704 out of port 704 via exterior opening 708. When speaker 720 stops playing the sound, passive radiator 710 may contract inwards towards volume 724, and port 704 may draw in air from the exterior of device 700 via exterior opening 708.

In the example of FIG. 7, passive radiator 710 may be placed in any suitable orientation, such as in order to minimize the footprint of passive radiator 710 within enclosure 702. As such, passive radiator 710 may not necessarily be positioned such that the membrane of passive radiator is parallel to back side 728 of speaker 720. In the example of FIG. 7, while passive radiator 710 faces back side 728 of speaker 720, passive radiator 710 may be positioned to be non-parallel to back side 728 of speaker 720.

Aspects of this disclosure include the following examples.
Example 1. A device comprising: an enclosure including a port having an exterior opening and one or more interior openings; a speaker positioned within the enclosure; an electronic device positioned at the one or more interior openings of the port; and a passive radiator positioned at the one or more interior openings of the port, wherein the passive radiator is operable to be driven by sound emitted by the speaker to vibrate and expel liquid in the port out of the exterior opening of the port.
Example 2. The device of example 1, wherein the one or more interior openings include a first interior opening and a second interior opening, wherein the port is positioned at the first interior opening of the port, and wherein the electronic device is positioned at a second interior opening of the port.
Example 3. The device of example 2, wherein the first interior opening and the second interior opening are disposed non-collinearly with respect to each other.
Example 4. The device of any of examples 2 and 3, wherein the port forms a first conduit between the exterior opening and the first interior opening and a second conduit between the exterior opening and the second interior opening, and wherein at least one of the first conduit and the second conduit is a non-straight conduit.
Example 5. The device of any of examples 1-4, wherein the passive radiator is positioned at an interior opening of the one or more interior openings of the port, wherein the port between the interior opening and the exterior opening forms a Venturi tube, wherein the interior opening is an opening of an entry cone of the Venturi tube, and wherein the exterior opening of the port is an opening of an exit cone of the Venturi tube.
Example 6. The device of any of examples 1-5, wherein the electronic device is a microphone.
Example 7. The device of example 6, wherein the passive radiator is tuned to be driven at a sound frequency that is below a passband of the microphone.
Example 8. The device of any of examples 1-7, wherein the passive radiator is tuned to be driven by the sound frequency that is at or below 100 hertz.
Example 9. The device of example 8, wherein the passive radiator is tuned to be driven by the sound frequency that is between 10 hertz and 100 hertz.
Example 10. The device of any of examples 1-6, wherein the passive radiator is tuned to be driven by the sound frequency that is between 100 hertz and 200 hertz.
Example 11. The device of any of examples 6-10, further comprising: a barometric vent coupled to a moving membrane of the passive radiator, wherein the barometric vent has a time constant that is below operating ranges of the speaker and the microphone.
Example 12. The device of any of examples 1-11, wherein the passive radiator is positioned to face a back side of the speaker, wherein the back side of the speaker is on an opposite side of the speaker from a speaker diaphragm operably coupled to the speaker, and wherein the passive radiator is separated from the back side of the speaker by a volume within the enclosure.
Example 13. The device of example 12, wherein the passive radiator is positioned to be non-parallel to the back side of the speaker.
Example 14. The device of any of examples 1-13, further comprising: processing circuitry configured to drive the speaker to emit the sound that cause the passive radiator to vibrate and expel liquid in the port out of the exterior opening of the port.
Example 15. The device of any of examples 1-13, wherein the device is a wearable computing device.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various aspects have been described in this disclosure. These and other aspects are within the scope of the following claims.

1-15. (canceled)

16. A device comprising:
an enclosure including a port having an exterior opening and one or more interior openings;
a speaker positioned within the enclosure;
an electronic device positioned at the one or more interior openings of the port; and
a passive radiator positioned at the one or more interior openings of the port, wherein the passive radiator is operable to be driven by sound emitted by the speaker to vibrate and expel liquid in the port out of the exterior opening of the port.

17. The device of claim 16, wherein the one or more interior openings include a first interior opening and a second interior opening, wherein the port is positioned at the first interior opening of the port, and wherein the electronic device is positioned at a second interior opening of the port.

18. The device of claim 17, wherein the first interior opening and the second interior opening are disposed non-collinearly with respect to each other.

19. The device of claim 17, wherein the port forms a first conduit between the exterior opening and the first interior opening and a second conduit between the exterior opening and the second interior opening, and wherein at least one of the first conduit and the second conduit is a non-straight conduit.

20. The device of claim 19, wherein the first interior opening adjoins the second interior opening.

21. The device of claim 16, wherein the passive radiator is positioned at an interior opening of the one or more interior openings of the port, wherein the port between the interior opening and the exterior opening forms a Venturi tube, wherein the interior opening is an opening of an entry cone of the Venturi tube, and wherein the exterior opening of the port is an opening of an exit cone of the Venturi tube.

22. The device of claim 16, wherein the electronic device is a microphone.

23. The device of claim 22, wherein the passive radiator is tuned to be driven at a sound frequency that is below a passband of the microphone.

24. The device of claim 16, wherein the passive radiator is tuned to be driven by a sound frequency that is at or below 100 hertz.

25. The device of claim 24, wherein the passive radiator is tuned to be driven by the sound frequency that is between 10 hertz and 100 hertz.

26. The device of claim 16, wherein the passive radiator is tuned to be driven by the sound frequency that is between 100 hertz and 200 hertz.

27. The device of claim 22, further comprising:
a barometric vent coupled to a moving membrane of the passive radiator, wherein the barometric vent has a time constant that is below operating ranges of the speaker and the microphone.

28. The device of claim 16, wherein the passive radiator is positioned to face a back side of the speaker, wherein the back side of the speaker is on an opposite side of the speaker from a speaker diaphragm operably coupled to the speaker, and wherein the passive radiator is separated from the back side of the speaker by a volume within the enclosure.

29. The device of claim 28, wherein the passive radiator is positioned to be non-parallel to the back side of the speaker.

30. The device of claim 28, wherein the passive radiator is positioned to be parallel to be back side of the speaker.

31. The device of claim 16, further comprising:
processing circuitry configured to drive the speaker to emit the sound that cause the passive radiator to vibrate and expel liquid in the port out of the exterior opening of the port.

32. The device of claim 31, wherein the processing circuitry is further configured to:
receive user input selecting a liquid ejection functionality; and
in response to receiving the user input, drive the speaker to emit the sound that cause the passive radiator to vibrate and expel liquid in the port out of the exterior opening of the port.

33. The device of claim 16, wherein the electronic device is a barometer.

34. The device of claim 16, wherein the electronic device is a charging contact for the device.

35. The device of claim 16, wherein the device is a wearable computing device.
